(19) United States
(12) Patent Application Publication
(10) Pub. No.: US 2023/0230331 A1
(43) Pub. Date: Jul. 20, 2023

(54) PRIOR BASED GENERATION OF THREE-DIMENSIONAL MODELS

(71) Applicant: QUALCOMM Incorporated, San Diego, CA (US)

(72) Inventors: Yan DENG, La Jolla, CA (US); Michel Adib SARKIS, San Diego, CA (US); Ning BI, San Diego, CA (US)

(21) Appl. No.: 17/567,678

(22) Filed: Jan. 3, 2022

(51) Int. Cl. G06T 19/20; G06T 17/10; G06T 13/40

(52) U.S. Cl. CPC G06T 19/20; G06T 13/40; G06T 17/10; G06T 2219/2021

(57) ABSTRACT

The present disclosure generally relates to systems and techniques for constructing three-dimensional (3D) models. Certain aspects of the present disclosure provide an apparatus for model generation. The apparatus generally includes a memory, and one or more processors coupled to the memory. The one or more processors and the memory may be configured to receive one or more images depicting an object to be modeled, determine a category associated with the object to be modeled, select a shape of a space based on the category, and generate a 3D model of the object at least in part by carving one or more points associated with the space based on the one or more images depicting the object.

### FIELD

The present disclosure generally relates to systems and techniques for constructing three-dimensional (3D) models.

### BACKGROUND

Many devices and systems allow a scene to be captured by generating frames (also referred to as images) and/or video data (including multiple images or frames) of the scene. For example, a camera or a computing device including a camera (e.g., a mobile device such as a mobile telephone or smartphone including one or more cameras) can capture a sequence of frames of a scene. The frames and/or video data can be captured and processed by such devices and systems (e.g., mobile devices, IP cameras, etc.) and can be output for consumption (e.g., displayed on the device and/or other device). In some cases, the frame and/or video data can be captured by such devices and systems and output for processing and/or consumption by other devices.

A frame can be processed (e.g., using object detection, recognition, segmentation, etc.) to determine objects that are present in the frame, which can be useful for many applications. For instance, a model can be determined for representing an object in a frame, and can be used to facilitate effective operation of various systems. Examples of such applications and systems include augmented reality (AR), robotics, automotive and aviation, three-dimensional scene understanding, object grasping, object tracking, in addition to many other applications and systems.

### BRIEF SUMMARY

In some examples, systems and techniques are described herein for generating one or more models. According to at least one example, a process for generating one or more models includes: Certain aspects of the present disclosure are directed towards an apparatus for model generation. The apparatus includes at least one memory and one or more processors coupled to the least one memory. The one or more processors are configured to: receive one or more images depicting an object to be modeled; determine a category associated with the object to be modeled, select a shape of a space based on the category; and generate a three-dimensional (3D) model of the object at least in part by carving one or more points associated with the space based on the one or more images depicting the object.

Certain aspects of the present disclosure are directed towards a method for model generation. The method generally includes receiving one or more images depicting an object to be modeled, determining a category associated with the object to be modeled, selecting a shape of a space based on the category, and generating a 3D model of the object at least in part by carving one or more points associated with the space based on the one or more images depicting the object.

Certain aspects of the present disclosure are directed towards a non-transitory computer-readable medium having instructions stored thereon that, when executed by one or more processors, cause the one or more processors to receive one or more images depicting an object to be modeled, determine a category associated with the object to be modeled, select a shape of a space based on the category, and generate a 3D model of the object at least in part by carving one or more points associated with the space based on the one or more images depicting the object.

In some aspects, the apparatus is, is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates cameras capturing different angles of an object from different viewpoints.

FIG. 2 illustrates human hair images from different angles, including a front view and side views that are each at a 45° angle with respect to the front view.

FIG. 3 illustrates a human hair model from different angles, including a front view, a back view, and a side view.

FIGS. 4A and 4B illustrate models of human hair generated using incomplete information.

FIGS. 5A and 5B illustrate examples of carving spaces, in accordance with certain aspects of the present disclosure.

FIG. 6 illustrates a model of human hair generated with incomplete information using a prior-based carving space, in accordance with certain aspects of the present disclosure.

FIG. 7 is a flow diagram illustrating example operations for model generation, in accordance with certain aspects of the present disclosure.

FIG. 8 is a diagram illustrating a signed distance function of points used to define a carving space.

FIG. 9A illustrates a model generated using a Euclidean norm, in accordance with certain aspects of the present disclosure.

FIG. 9B illustrates a model generated using an L1 norm, in accordance with certain aspects of the present disclosure.

FIGS. 10A and 10B show models of human hair generated based on prior-based carving spaces, respectively, in accordance with certain aspects of the present disclosure.

FIG. 11 is a diagram illustrating an example of a 3D morphable model (3DMM) of a human head.

FIG. 12 is a diagram illustrating an example of a process for performing object reconstruction based on a 3DMM technique.

FIG. 13 illustrates example operations for model generation, in accordance with certain aspects of the present disclosure.

FIG. 14 is a diagram illustrating an example of a system for implementing certain aspects of the present technology.

### DETAILED DESCRIPTION

Certain aspects and aspects of this disclosure are provided below and some of these aspects may be applied independently and some of them may be applied in combination. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

Generation of three-dimensional (3D) models for physical objects can be useful for many systems and applications, such as for extended reality (XR) (e.g., including augmented reality (AR), virtual reality (VR), mixed reality (MR), etc.), robotics, automotive (e.g., for autonomous vehicles, vehicle-to-everything (V2X) systems or applications, and/or other automatic systems or applications), aviation, 3D scene understanding, object grasping, object tracking, in addition to many other systems and applications. In AR environments, for example, a user may view images (also referred to as frames or pictures) that include an integration of artificial or virtual graphics with the user’s natural surroundings. AR applications allow real images to be processed to add virtual objects to the images and to align or register the virtual objects to the images in multiple dimensions. For instance, a real-world object that exists in reality can be represented using a model that resembles or is an exact match of the real-world object. In one example, a model of a virtual airplane representing a real airplane sitting on a runway may be presented in the view of an AR device (e.g., AR glasses, AR head-mounted display (HMD), or other device) while the user continues to view his or her natural surroundings in the AR environment. The viewer may be able to manipulate the model while viewing the real-world scene. In another example, an actual object sitting on a table may be identified and rendered with a model that has a different color or different physical attributes in the AR environment. In some cases, artificial virtual objects that do not exist in reality or computer-generated copies of actual objects or structures of the user’s natural surroundings can also be added to the AR environment.

There is an increasing number applications that use face data (e.g., for XR systems, for 3D graphics, for security, among others), leading to a large demand for systems with the ability to generate detailed 3D face models (as well as 3D models of other objects) in an efficient and high-quality manner. There also exists a large demand for generating 3D models of other types of objects, such as 3D models of vehicles (e.g., for autonomous driving systems), 3D models of room layouts (e.g., for XR applications, for navigation by devices, robots, automotive systems, etc.), among others.

One example technique for generating a 3D model of an object is space carving, as described herein. Space carving can be used to generate a 3D model of an object by starting with an initial volume (e.g., also referred to herein as an initial carving space) and carving away space (or points, such as voxels) on the volume until it converges to the 3D model of the object. Generating a detailed 3D model of an object (e.g., a 3D face model) using space carving typically involves using one or more cameras to capture images of an object from different angles.

Certain aspects of the present disclosure provide systems and techniques for model generation using space carving. As noted above, space carving is a technique by which points (e.g., voxels, vertices, or other points) of a carving space are carved (e.g., deleted or designated as being external to the model) based on images of an object to be modeled. A voxel generally refers to an element on a grid in a 3D space (e.g., points in 3D space). Multiple images of the object from different angles may be received, each showing a different representation (e.g., silhouette, shape, or other representation) of the object. Based on the images, points that are not part of a three-dimensional (3D) model of the object to be generated are carved until the carving space represents the object. However, in some scenarios, the images of the object may not include views from all sides of the object. For example, when modeling human hair, an image of the back of the human hair may not be available. As a result, the generated 3D model may have incomplete information, resulting in a hole in the model. In some applications, the hole may be filled (e.g., covered) using a flat shape resulting in an unnatural look.

Certain aspects of the present disclosure provide systems and techniques for completing the 3D model given the incomplete information, such that the 3D model has a natural look. An initial carving space (also referred to as a prior-based carving space) that is used for the 3D modeling may be selected based on a category of the object being modeled. In one illustrative example, the object being modeled is human hair where images of the back of the human hair are unavailable. In such an example, an initial carving space with a quarter sphere connected with a cubic shape may be selected such that the back of the 3D model has a natural curve resembling the back of human hair.

Certain aspects provide systems and techniques for determining a scale and a position of the carving space. In some implementations, the scale and position of the carving space may be determined based on a model of a related object (e.g., a human head) that abuts the object (e.g., human hair) being modeled using space carving. As an example, when using space carving to model human hair, the carving space may include a portion (e.g., a quarter) of a sphere, as described herein. The sphere’s center may be set to be at a center point between certain points of the model, such as a center point between temple points of the human head model. The scale of the sphere may be determined based on a distance from the back of the human head model to the center point between the temple points. In some cases, the scale of the sphere may additionally include a padding distance to account for the hair. The padding distance may depend on the style of the hair being modeled.

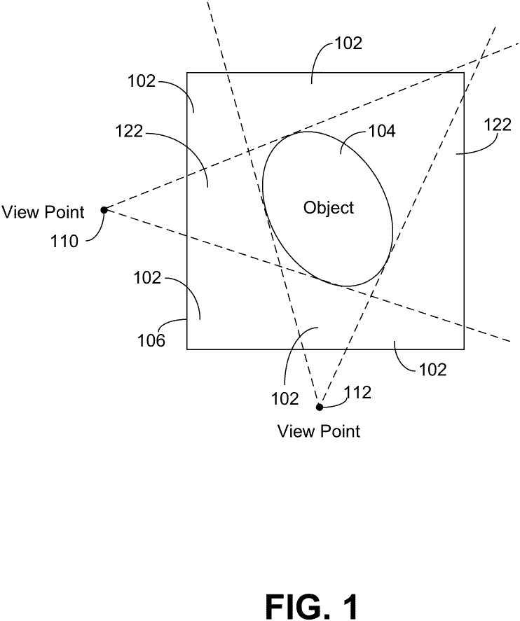

FIG. 1 illustrates cameras capturing different angles of an object from different viewpoints 110, 112. Based on an image from viewpoint 110, areas 102 associated with an initial carving space 106 may be carved by removing points (e.g., voxels) from the areas 102. Carving a point generally refers to the point being designated as external to a model to be generated. For example, the image from viewpoint 110 may show a representation (e.g., a silhouette) of object 104, based on which points in areas 102 may be removed from the carving space. Based on an image captured from viewpoint 112, points in areas 122 may be removed from the carving space. This process may be repeated from different viewpoints until the remaining carving space resembles the object 104. While FIG. 1 provides a simple carving technique to facilitate understanding, the aspects described herein are applicable to any suitable space carving technique where points are systematically removed from a carving space to represent an object in 3D space. For example, while images from only two viewpoints are described, space carving may be performed with any number of images from one or more viewpoints.

In order to generate a complete 3D model of an object using space carving, images providing 360° views of the object are typically used. However, in many scenarios, it may not be possible to obtain images from all angles of an object and there may be incomplete information with respect to a portion of the object. As a result, a 3D model of the object may be created without complete information regarding the shape of the object, resulting in a hole in the corresponding model. As one example, a camera may capture a head of hair at different angles without capturing the profile view (e.g., 90 and -90 degrees in yaw direction) of the hair. For instance, a user may use a mobile device to capture several images of the user’s head, but may not be able to capture images that include the profile view of the user’s head. In such an example, a 3D model generated using space carving may have a hole where the back of the hair should be.

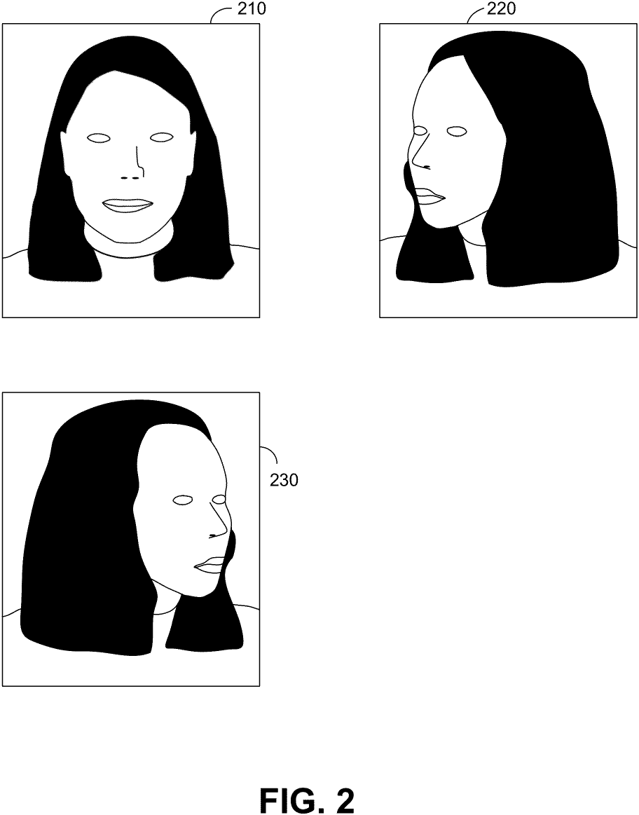

FIG. 2 illustrates images captured of human hair from different angles, including a front view 210 and side views 220, 230 that are each at a 45° angle with respect to the front view. As shown, the profile view of the hair is not captured in any of the images. Therefore, a 3D model of the hair may be generated with incomplete information regarding the back of the hair, resulting in a hole in the model.

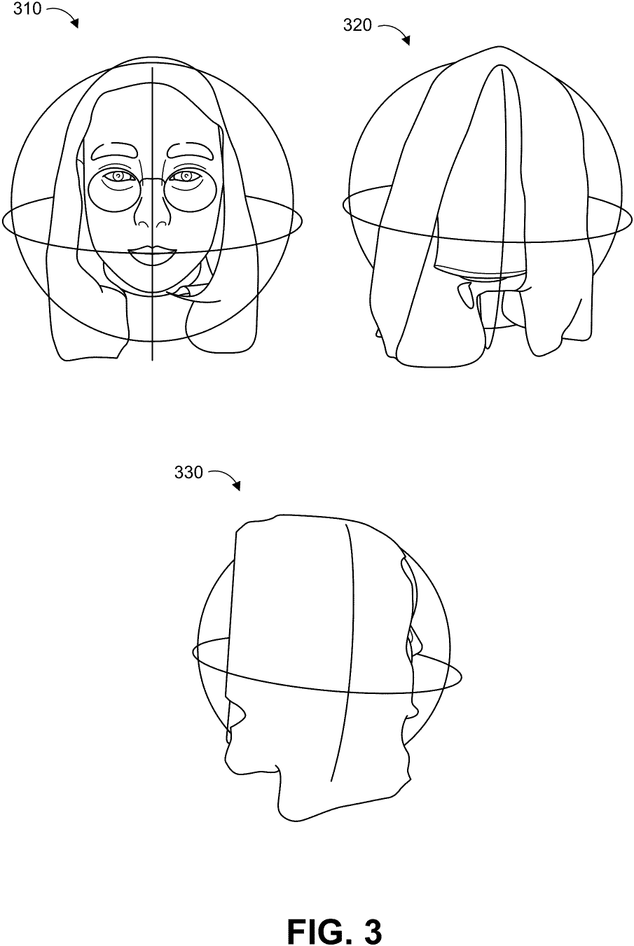

FIG. 3 illustrates a model of human hair from different angles, including a front view 310, a back view 320, and a side view 330. As shown in the back view 320, there is a hole in the model of the hair due to a lack of two images from the profile (e.g., 90 and -90 degrees in yaw directions) of the hair being available. Similarly, side view 330 shows a flat back of the hair which looks unnatural. In some implementations, a hole filling technique may be used to fill in the hole in the object. For example, the hole filling technique may involve filling in the hole (e.g., covering the hole) in the model and the boundary condition will lead to an almost flat surface, resulting in an unnatural look.

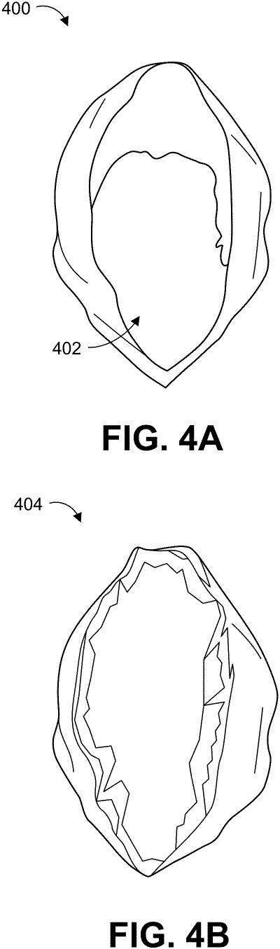

FIGS. 4A and 4B illustrate models 400, 404 of human hair generated using incomplete information. As shown in FIG. 4A, model 400 of human hair is implemented without hole filling. Therefore, a hole 402 exists in the back of the hair model. The model 404 shown in FIG. 4B is implemented by performing hole filling on model 400 to fill hole 402. As shown, hole 402 is filled and an almost flat surface is included as result, causing the model to have an unnatural look.

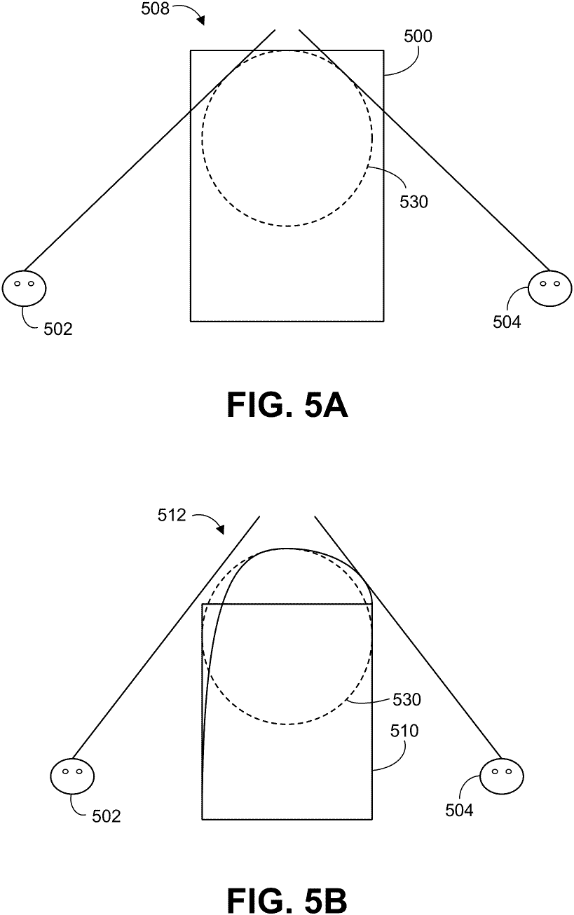

FIG. 5A illustrates a typical carving space 500. As shown, a carving space having a particular shape may be initialized such that an object to be modeled is enclosed in the carving space. Based on a representation, such as a silhouette (e.g., outline), of the object from viewpoints 502, 504, points (e.g., voxels or other points) of the carving space may be carved until the carving space represents a model 530 to be generated. However, as described herein, views from all angles of the object may be unavailable. In certain aspects of the present disclosure, a prior-based carving space may be used to obtain a more natural model of the object given the incomplete information regarding the object.

FIG. 5B illustrates a prior-based carving space 510, in accordance with certain aspects of the present disclosure. The prior-based carving space 510 can be based on the specific object that is being modeled. For instance, in some cases, the carving space 510 is tailored to a specific category to which the object to be modeled belongs. In one illustrative example, a modeling system may know that the object to be modeled is a specific type of hair. The modeling system may use (e.g., select) the carving space 510 (e.g., from a list of carving space options) based on the category of object (e.g., based on the specific type of hair). By using the carving space 510 that is specific to the object to be modeled, the carving space 510 can provide a natural look for a 3D model of the object given that an image of a portion of the object is not available. For instance, instead of using a flat backside 508 of the carving space as shown in FIG. 5A, a curved backside 512 may be used (e.g., based on the object being hair and the missing portion being the back of the hair) as shown in FIG. 5B. In the example of the object being hair noted above, the curved backside 512 may be set to resemble a backside of the human hair, as shown by the model 530 to be generated. Thus, although an image of the back of the hair may not be available, since the initial carving space 510 uses a curved backside in an attempt to imitate the look of hair, a more natural look for the model is attained.

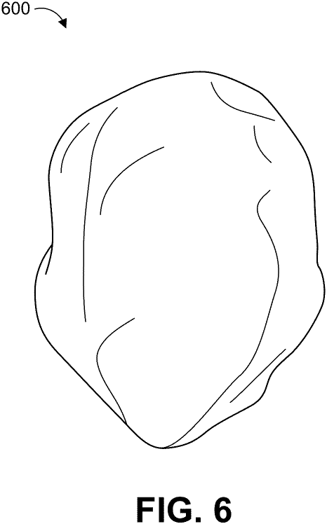

FIG. 6 illustrates a model 600 of human hair generated with incomplete information using a prior-based carving space, in accordance with certain aspects of the present disclosure. As shown, even without an image from the back of the human hair, a natural curve may be attained due to the specific carving space that is selected.

While examples provided herein have described using a prior-based carving space for modeling human hair to facilitate understanding, the aspects described herein can be used to model any suitable object, such as a human body or a car. For example, if the modeling system determines that an object to be modeled is a car, a prior-based carving space may be used to include a shape of at least a portion of the car that is not shown in images. If image data is not available from the trunk portion of the car, the prior-based carving space may provide a more natural look for the model by having a back portion in the shape of a car trunk.

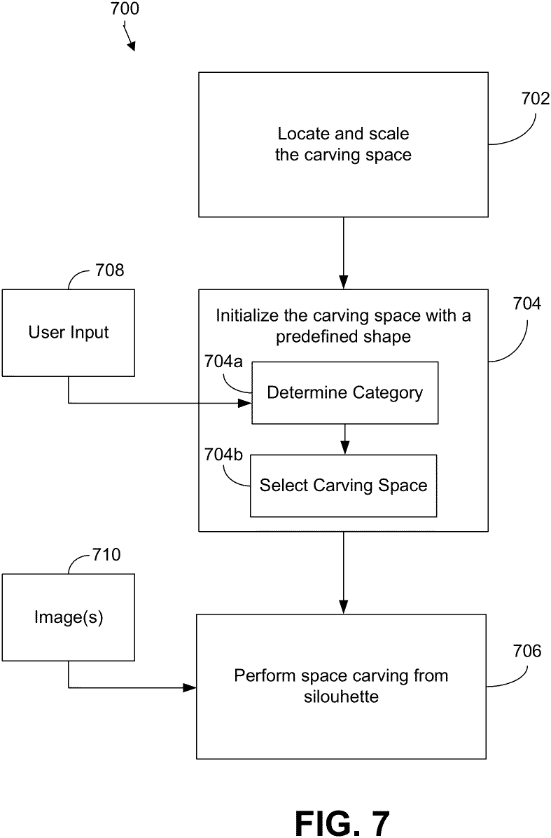

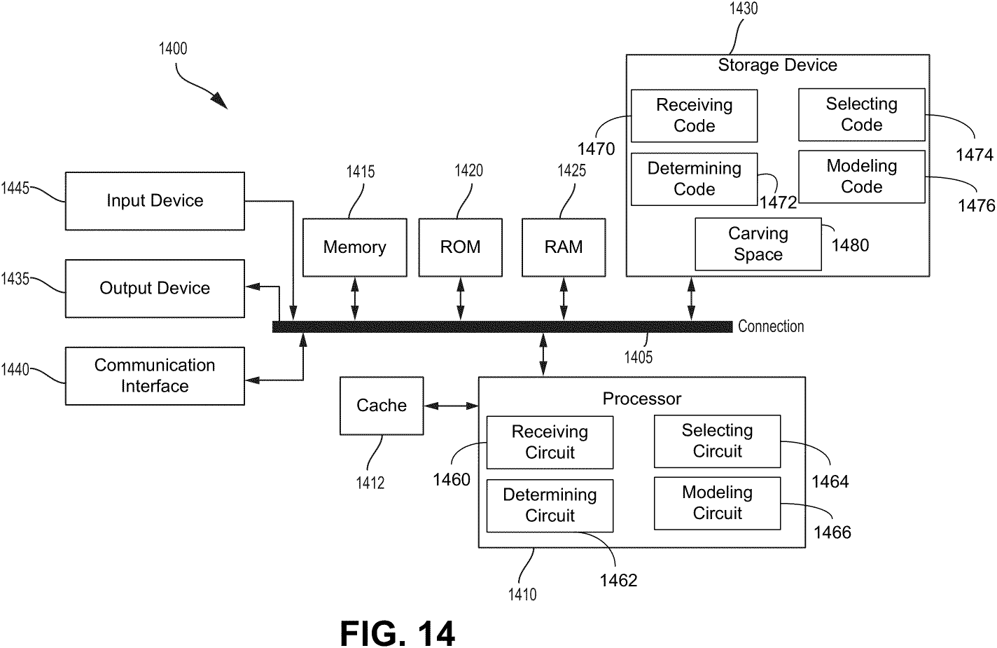

FIG. 7 is a flow diagram illustrating an example of a process 700 for model generation, in accordance with certain aspects of the present disclosure. The operations of process 700 may be performed by a modeling system including one or more processors such as the processor 1410 of FIG. 14, and in some aspects, a memory such as the storage device 1430 of FIG. 14.

At block 702, the modeling system can include locating and scaling a space, such as a carving space. Any locating technique may be used to determine where the carving space is located relative to the object in an image. In one example, the modeling system can determine a center of the carving space and the scale of the carving space in x (horizontal), y (vertical), and z (depth) dimensions. The position and scale of the carving space are determined for the model of the object to be enclosed by the carving space while also attempting to align a side (e.g., backside 512) of the carving space with a corresponding side of the object in the image (e.g., backside of the human hair). For instance, referring back to FIG. 5B, if the scale and position of the carving space is set properly, the backside 512 appropriately represents the corresponding portion of the object, such as the backside of the human hair, as shown by model 530. One example locating and scaling technique may use a 3D morphable model (3DMM), as described in more detail herein.

At block 704, the modeling system may initialize the carving space with a predefined shape. For example, the modeling system may select an initial shape for the carving space by determining a category or classification (also referred to as a class) associated with the object at block 704a. The category of the object may be determined using a specific categorization algorithm. For example, one or more images of the object may be received and input to the categorization or classification algorithm. The categorization algorithm may then determine the category (e.g., car or human body) of the object. In some implementations, the categorization algorithm may be a machine learning model (e.g., a classification convolutional neural network (CNN)) trained to identify a category or class of objects from one or more images. In other aspects, the category may be determined at block 704a by receiving user input 708. For example, the user input 708 may include an indication of the category, such as an indication that the object is human hair, or in some cases, a style of the human hair.

Once the category is determined, the modeling system can select a corresponding carving space at block 704b, as shown. For example, a set of candidate carving spaces (e.g., candidate carving spaces 1480 of FIG. 14) may be saved in memory (e.g., storage device 1430). The modeling system may select one of the candidate carving spaces based on the corresponding category.

At block 706, the modeling system can use the selected carving space to model the object. For example, the modeling system may receive one or more images 710 of the object. Based on a representation (e.g., a silhouette) of the object as shown in the image, the modeling component may begin to carve points of the carving space until the carving space represents the object, as described herein. For example, as described with respect to FIG. 1, the modeling system may determine a representation (e.g., a silhouette) of object 104, and determine which points of the carving space correspond to areas (e.g., areas 102 for viewpoint 110) that are outside the representation of the object 104, which are then carved. This process is repeated until the carving space becomes a model of the object.

In some aspects, the process 700 may be repeated based on images of the object obtained at different times. Thus, multiple models of the object may be generated. The multiple models may be used to generate an animation of the object (e.g., showing the movement of the object in a 3D environment).

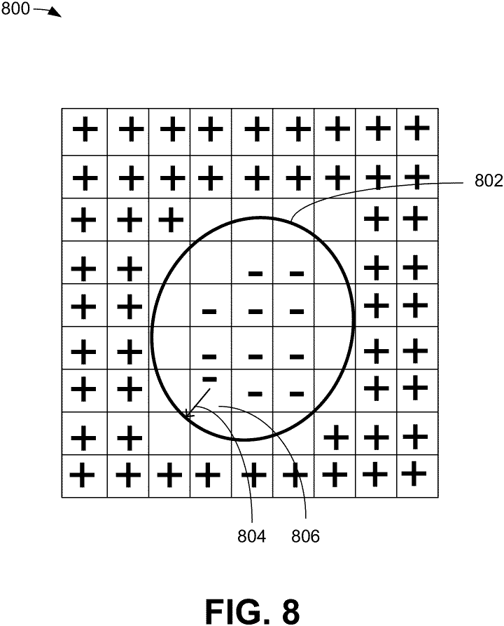

FIG. 8 is a diagram illustrating a signed distance function (sdf) of points, shown as voxels 800, used to define a carving space 802. Each of voxels 800 may be associated with a distance defined using the signed distance function. The signed distance function provides, for each voxel (v), a distance from the voxel to the nearest point on a boundary associated with the object (e.g., carving space 802), where {s} represents all the points residing on the boundary associated with the object (e.g., carving space 802). For example, if a voxel (v) is outside of the boundary associated with the object, then:

$$s d f \left(v\right) = min \left|v - \left\{s\right\}\right|$$

If the voxel is inside the boundary associated with the object, then:

$$s d f \left(v\right) = - m i n \left|v - \left\{s\right\}\right|$$

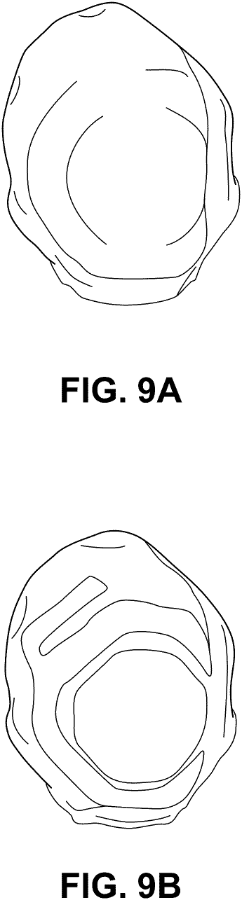

Therefore, the distance for each voxel is represented as a negative number if the voxel is inside the boundary associated with the object and is represented as a positive number if the voxel is outside the boundary associated with the object, as shown. For example, distance 804 from voxel 806 to the nearest point on the boundary associated with the object is a negative number. The calculation of the distance for each voxel may be based on any suitable norm function. Some examples of norm functions include an L1 norm or L2 norm (e.g., also referred to as a Euclidean norm), which are described below with respect to FIGS. 9A and 9B.

FIG. 9A illustrates a model generated using the Euclidean norm (e.g., an L2 norm) and FIG. 9B illustrates a model generated using an L1 norm, in accordance with certain aspects of the present disclosure. L1 and L2 norms represent p-norm where p equals 1 for L1 norm and p equals 2 for L2 norm. For example, p-norm of vector x = (xi,...xn) is represented by equation:

$${\left‖x\right‖}_{p} = {\left({\sum }_{i = 1}^{n} {\left|{x}_{i}\right|}^{p}\right)}^{1 / p}$$

where ||x|| = |x| and is a norm on the one-dimensional vector spaces. As shown, a model generated using an L1 norm (e.g., as shown in FIG. 9B) may provide a more natural look for human hair representation as compared to a model generated using an L2 norm (e.g., as shown in FIG. 9A).

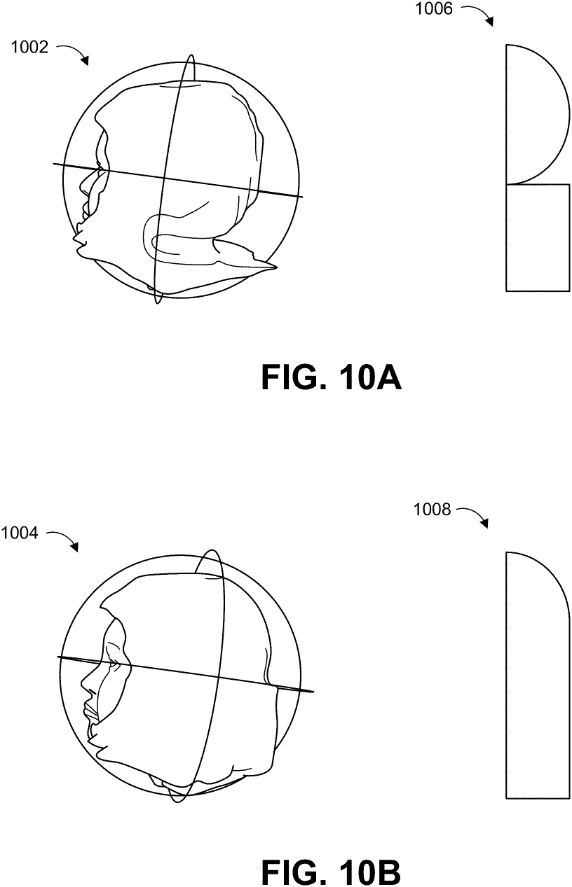

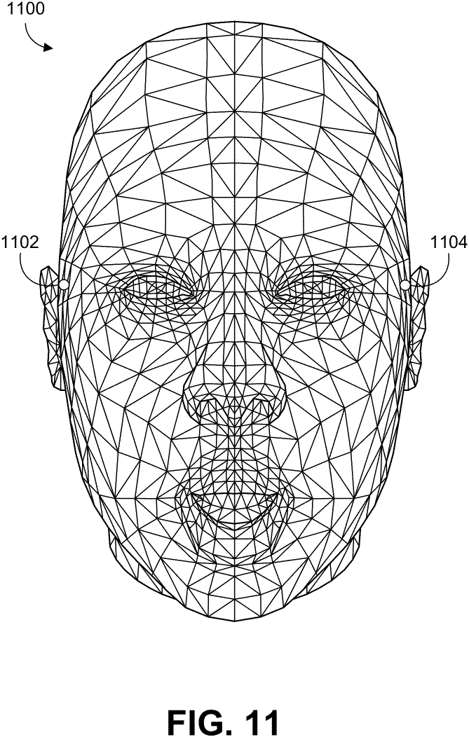

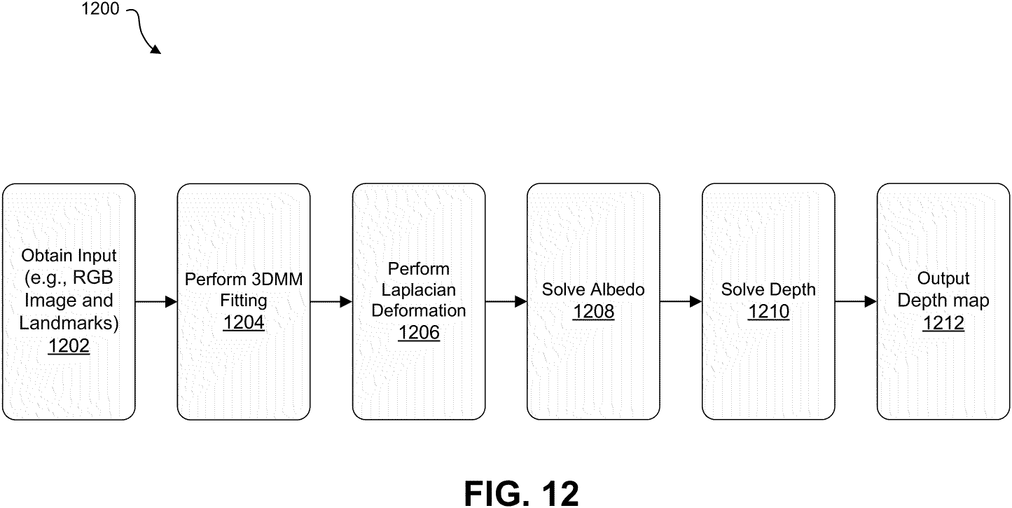

FIGS. 10A and 10B show models 1002, 1004 of human hair generated based on prior-based carving spaces 1006, 1008, respectively, in accordance with certain aspects of the present disclosure. The shape and the location of the carving space are important for generating a natural looking model. As shown, the shape of the carving space 1006 generates an unnatural looking model of human hair. In contrast, the shape of the carving space 1008 which uses a quarter sphere over a cubic space generates a more natural looking model of human hair. A 3DMM may be used to select the position and scale of the carving space such that the initial carving space is appropriately positioned with respect to the eventual model to be generated. Techniques for generating a 3DMM are described in more detail herein with respect to FIGS. 11 and 12.

FIG. 11 is a diagram illustrating an example of a 3DMM 1100 of a human head. The 3DMM 1100 does not include non-rigid aspects of the person, such as the hair region or a clothing region. The 3DMM 1100 can be morphed to depict various facial movement of the object (e.g., nasal region, ocular region, oral region, etc.). As an example, over a number of images, the 3DMM 1100 can change to allow illustration of the person speaking or facial expressions such as the person smiling. In other examples, an object being modeled using 3DMM can be any physical object, such as a person, an accessory, a vehicle, a building, an animal, a plant, clothing, and/or other object.

Once a 3DMM model is generated of a human head (e.g., without the hair), the carving space for modeling the hair may be positioned and scaled accordingly. For example, as described with respect to FIG. 10B, the carving space 1008 may have a quarter sphere shape. The sphere’s center may be positioned around the mid-point of the temple area of the 3DMM model. The sphere’s radius may depend on the scale of the fitted 3DMM head.

The points 1102, 1104 represent the temple points of the human head. The radius of the sphere of carving space 1008 may be selected such that the back perimeter of the sphere is aligned with the back of the 3DMM model of the head plus a padding distance to account for the hair to be modeled (e.g., to extend the sphere out of the skull region of the 3DMM model). For example, the scale of the head may be calculated based on a distance between the back of the head to the mid-point between temple points 1102, 1104 plus a padding distance to account for the hair. The padding distance may be determined based on hair style or set heuristically. In other words, the amount of padding may depend on the type of style of the hair being modeled if known using a categorization algorithm or based on user input.

To generate a 3DMM model, a 3D object modeler (modeling circuit 1466 of FIG. 14) can process one or more frames (e.g., images) from a sequence of frames to generate a 3D model of at least a portion of an object, such as the human head. A 3DMM model generated using 3DMM fitting is a statistical model representing 3D geometry and texture of an object. For instance, a 3DMM can be represented by a linear combination of basis terms with coefficients for shape Xₛₕₐₚₑ, expression Xₑₓₚᵣₑₛₛᵢₒₙ, and texture X_{albedo}, for example as follows:

$$V e r t i c e {s}_{3 D \_ c o o r d i n a t e} = {X}_{s h a p e} B a s i {s}_{s h a p e} + {X}_{e x p r e s s i o n} B a s i {s}_{e x p r e s s i o n}$$

$$V e r t i c e {s}_{c o l o r} = C o l o {r}_{m e a n \_ a l b e d o} + {X}_{a l b e d o} B a s i {s}_{a l b e d o}$$

Equation (1) is used to determine the position of each vertex of the 3DMM model, and Equation (2) is used to determine the color for each vertex of the 3DMM model.

FIG. 12 is a diagram illustrating an example of a process 1200 for performing object reconstruction based on the 3DMM technique. At operation 1202, the process 1200 includes obtaining an input, including an image (e.g., an RGB image) and landmarks (e.g., facial landmarks or other landmarks uniquely identifying an object). At operation 1204, the process 1200 performs the 3DMM fitting technique to generate a 3DMM model. The 3DMM fitting includes solving for the shape (e.g., Xₛₕₐₚₑ), expression (e.g., Xₑₓₚᵣₑₛₛᵢₒₙ), and albedo (e.g., X_{albedo}) coefficients of the 3DMM model of the object (e.g., the face). The fitting can also include solving for the camera matrix and spherical harmonic lighting coefficients.

At operation 1206, the process 1200 includes performing a Laplacian deformation to the 3DMM model. For example, the Laplacian deformation can be applied on the vertices of the 3DMM model to improve landmark fitting. In some cases, another type of deformation can be performed to improve the landmark fitting. At operation 1208, the process 1200 includes solving for albedo. For example, the process 1200 can fine-tune albedo coefficients to split out colors not belonging to a spherical harmonic lighting model. At operation 1210, the process 1200 solves for depth. For example, the process 1200 can determine per-pixel depth displacements based on a shape-from-shading formulation or other similar function. The shape-from-shading formulation defines a color for each point of the 3DMM model as a multiplication of the albedo color multiplied by a light coefficient. For instance, the color seen in an image is formulated as the albedo color multiplied by the light coefficient. The light coefficient for a given point is based on the surface normal of the point. At operation 1212, the process 1200 includes outputting a depth map and/or a 3D model (e.g., outputting the 3DMM).

In some cases, a 3DMM model can be used to describe an object space (e.g., 3D face space) with principal component analysis (PCA). Below is an example Equation (3) that can be used to describe a shape of a 3D object (e.g., a 3D head shape):

$$S = \overline{S} + {A}_{i d} {α}_{i d} + {A}_{e x p} {α}_{e x p} ,$$

Using a head as an example of a 3D object, S is the 3D head shape, S̅ is the mean face shape, A_{id} is the eigenvectors (or principal components) trained on 3D face scans with neutral expression, α_{id} is a shape coefficient, Aₑₓₚ is the eigenvectors trained on the offsets between expression and neutral scans, and aₑₓₚis the expression coefficient. The 3DMM head shape can be projected onto an image plane using a projection technique, such as using a weak perspective projection. Example Equations (4) and (5) below can be used to calculate an aligned face shape:

$$\text{I} \text{=} m P R \left(α , β , γ\right) S + t$$

$$\text{I} \text{=} m P R \left(α , β , γ\right) \left(\overline{S} + {A}_{i d} {α}_{i d} + {A}_{e x p} {α}_{e x p}\right) + t$$

where I is the aligned face shape, S is the 3D face model, R(α,β,γ) is a 3 × 3 rotation matrix with α,β,γ rotation angles, m is a scale parameter, t is a translation vector, and P is the weak perspective transform.

Each 3DMM may be fitted to the object in each frame of the sequence of frames. Because the 3DMM is fitted to each frame in the sequence of frames, the accuracy of the 3DMM models may vary and may not be aligned. Further, an object can vary from frame to frame. For instance, a head of the person can also vary from frame to frame due to trembling, for example. As such, the 3DMM models can vary from frame to frame.

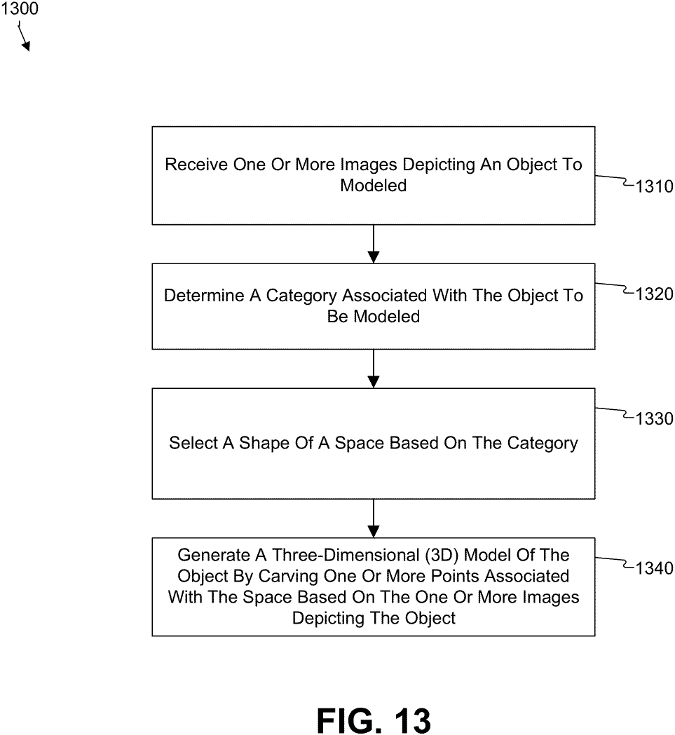

FIG. 13 illustrates example operations 1300 for model generation, in accordance with certain aspects of the present disclosure. The operations 1300 may be performed by a modeling system including one or more processors such as the processor 1410, and in some aspects, a memory such as the storage device 1430.

The operations 1300 begin, at block 1310, with the modeling system receiving one or more images depicting an object to be modeled. The one or more images may be received from a user.

At block 1320, the modeling system determines a category associated with the object to be modeled. In some aspects, the category may be determined based on user input. In some aspects, the modeling system may analyze, via a classification algorithm, the one or more images to determine the category.

At block 1330, the modeling system selects a shape of a space (e.g., carving space) based on the category. Selecting the shape of the space may include selecting one of multiple candidate spaces that is associated with the category.

At block 1340, the modeling system generates a 3D model of the object by carving one or more points (e.g., voxels) associated with the space based on the one or more images depicting the object. Carving the one or more points may involve designated the one or more points as being outside the 3D model of the object. The modeling system may determine that the one or more points to be carved are external to a silhouette of the object as shown by the one or more images.

In certain aspects, the processing system may determine a position and a scale associated with the space such that the 3D model of the object to be generated is enclosed within the space. For example, the position may be determined such that a side (e.g., backside 512 shown in FIG. 5B) of the space is aligned with a side of the 3D model to be generated. The side of the 3D model may be associated with a side of the object (e.g., back of the human hair) that is not shown in the one or more images.

In some aspects, the modeling system may generate a 3D model (e.g., a 3DMM) of a related object (e.g., human head) that abuts the object (e.g., human hair) being modeled. In this case, the position and scale associated with the space may be determined based on the 3D model of the related object.

In some aspects, the related object is a human head, and the object being modeled via the space is human hair on the human head. In this case, the shape of the space may include at least a portion (e.g., a quarter) of a sphere. The modeling system may determine the position of the space by setting a center associated with the sphere to be at a midpoint between temple points (e.g., points 1102, 1104) on the 3D model of the human head. The modeling system may determine the scale associated with the space based on a distance (e.g., a head radius distance) from a back of the 3D model of the human head to a midpoint between temple points on the 3D model of the human head, and in some aspects, based on the distance plus a padding distance to account for the human hair on the human head. The modeling system may determine the padding distance based on a style associated with the human hair.

In some aspects, the space may be represented by a signed distance function used to indicate, for each point of the space, a distance from the point to a closest point on a boundary associated with the object. The distance may be determined based on an L1 norm formula.

In some aspects, the modeling system may generate one or more other 3D models of the object at least in part by carving one or more other points associated with another space based on one or more other images depicting the object. In this case, the modeling system may generate an animation of the object based on the 3D model and the one or more other 3D models.

FIG. 14 is a diagram illustrating an example of a system for implementing certain aspects of the present technology. In particular, FIG. 14 illustrates an example of computing system 1400, which can be for example any computing device making up internal computing system, a remote computing system, a camera, or any component thereof in which the components of the system are in communication with each other using connection 1405. Connection 1405 can be a physical connection using a bus, or a direct connection into processor 1410, such as in a chipset architecture. Connection 1405 can also be a virtual connection, networked connection, or logical connection.

In some aspects, computing system 1400 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1400 includes at least one processing unit (CPU or processor) 1410 and connection 1405 that couples various system components including system memory 1415, such as read-only memory (ROM) 1420 and random access memory (RAM) 1425 to processor 1410. Computing system 1400 can include a cache 1412 of high-speed memory connected directly with, in close proximity to, or integrated as part of processor 1410.

Processor 1410 can include any general purpose processor and a hardware service or software service. In some aspects, code stored in storage device 1430 may be configured to control processor 1410 to perform operations described herein. In some aspects, the processor 1410 may be a special-purpose processor where instructions or circuitry are incorporated into the actual processor design to perform the operations described herein. Processor 1410 may essentially be a completely self-contained computing system, containing multiple cores or processors, a bus, memory controller, cache, etc. A multi-core processor may be symmetric or asymmetric. For example, the processor 1410 may include circuit 1460 for receiving (e.g., receiving one or more images), circuit 1462 for determining (e.g., determining a category), circuit 1464 for selecting (e.g., selecting a shape of a carving space from candidate carving spaces 1480), and circuit 1466 for modeling (e.g., generating a 3D model).

The storage device 1430 may store code which, when executed by the processors 1410, performs the operations described herein. For example, the storage device 1430 may include code 1470 for receiving (e.g., receiving one or more images), code 1472 for determining (e.g., determining a category), code 1474 for selecting (e.g., selecting a shape of a carving space from candidate carving spaces 1480), and code 1476 for modeling (e.g., generating a 3D model).

To enable user interaction, computing system 1400 includes an input device 1445, which can represent any number of input mechanisms, such as a microphone for speech, a camera for generating images or video, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400. Computing system 1400 can include communications interface 1440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some aspects, a hardware service that performs a particular function can include the software component stored in a computer-readable medium in connection with the necessary hardware components, such as processor 1410, connection 1405, output device 1435, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, mobile phones (e.g., smartphones or other types of mobile phones), tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: A method for model generation, comprising: receiving one or more images depicting an object to be modeled; determining a category associated with the object to be modeled; selecting a shape of a space based on the category; and generating a three-dimensional (3D) model of the object at least in part by carving one or more points associated with the space based on the one or more images depicting the object.

Aspect 2: The method of aspect 1, wherein selecting the shape of the space comprises selecting a space from multiple candidate spaces that is associated with the category.

Aspect 3: The method of any one of aspects 1-2, wherein the category is determined based on user input.

Aspect 4: The method of any one of aspects 1-3, further comprising analyzing, using a classification algorithm, the one or more images to determine the category.

Aspect 5: The method of any one of aspects 1-4, further comprising determining a position and a scale associated with the space, wherein the 3D model of the object to be generated is enclosed within the space based on the determined position and scale.

Aspect 6: The method of aspect 5, wherein the position is determined to align a side of the space with a side of the 3D model to be generated.

Aspect 7: The method of aspect 6, wherein the side of the 3D model is associated with a side of the object that is not depicted in the one or more images.

Aspect 8: The method of any one of aspects 5-7, further comprising generating a 3D model of an additional object that abuts the object, and wherein the position associated with the space is determined based on the 3D model of the additional object.

Aspect 9: The method of aspect 8, wherein the 3D model of the additional object is generated by generating a 3D morphable model (3DMM).

Aspect 10: The method of any one of aspects 8-9, wherein the additional object comprises a human head, and wherein the object comprises human hair on the human head.

Aspect 11: The method of any one of aspects 5-10, wherein: the shape of the space comprises at least a portion of a sphere, and determining the position of the space comprises setting a center associated with the sphere to be at a midpoint between two points on a 3D model of an additional object associated with the object.

Aspect 12: The method of any one of aspects 5-11, wherein: the object includes human hair on a human head; the shape of the space comprises at least a portion of a sphere; and determining the position of the space comprises setting a center associated with the sphere to be at a midpoint between temple points on a 3D model of the human head.

Aspect 13: The method of any one of aspects 5-12, wherein: the object includes human hair on a human head; the shape of the space comprises at least a portion of a sphere; and the scale associated with the space is determined based on a distance from a back of the 3D model of the human head to a midpoint between temple points on a 3D model of the human head.

Aspect 14: The method of aspect 13, wherein the scale associated with the space is determined based on the distance and a padding distance associated with the human hair on the human head.

Aspect 15: The method of aspect 14, further comprising determining the padding distance based on a style associated with the human hair.

Aspect 16: The method of any one of aspects 1-15, further comprising generating one or more other 3D models of the object at least in part by carving one or more other points associated with another space based on one or more other images depicting the object; and generating an animation of the object based on the 3D model and the one or more other 3D models.

Aspect 17: The method of any one of aspects 1-16, further comprising determining that the one or more points are external to a representation of the object as shown by the one or more images.

Aspect 18: The method of any one of aspects 1-17, wherein carving the one or more points comprises designated the one or more points as being outside the 3D model of the object.

Aspect 19: The method of any one of aspects 1-18, wherein the space is represented by a signed distance function used to indicate, for each point of the space, a distance from each point to a closest point on a boundary associated with the object.

Aspect 20: The method of aspect 19, wherein the distance is determined based on an L1 norm formula.

Aspect 21: A computer-readable medium comprising at least one instruction for causing a computer or processor to perform operations according to any of aspects 1 to 20.

Aspect 22: An apparatus for model generation, the apparatus including means for performing operations according to any of aspects 1 to 20.

Aspect 23: An apparatus for model generation. The apparatus includes at least one memory and at least one processor coupled to the at least one memory. The at least one processor is configured to perform operations according to any of aspects 1 to 20.

What is claimed is:

1. An apparatus for model generation, comprising:
a memory; and
one or more processors coupled to the memory, the one or more processors being configured to:
receive one or more images depicting an object to be modeled;
determine a category associated with the object to be modeled;
select a shape of a space based on the category; and
generate a three-dimensional (3D) model of the object at least in part by carving one or more points associated with the space based on the one or more images depicting the object.

2. The apparatus of claim 1, wherein, to select the shape of the space, the one or more processors are configured to select a space from multiple candidate spaces that is associated with the category.

3. The apparatus of claim 1, wherein the category is determined based on user input.

4. The apparatus of claim 1, wherein the one or more processors are further configured to analyze, using a classification algorithm, the one or more images to determine the category.

5. The apparatus of claim 1, wherein the one or more processors are further configured to determine a position and a scale associated with the space, wherein the 3D model of the object to be generated is enclosed within the space based on the determined position and scale.

6. The apparatus of claim 5, wherein the position is determined to align a side of the space with a side of the 3D model to be generated.

7. The apparatus of claim 6, wherein the side of the 3D model is associated with a side of the object that is not depicted in the one or more images.

8. The apparatus of claim 5, wherein the one or more processors are further configured to generate a 3D model of an additional object that abuts the object, and wherein the position associated with the space is determined based on the 3D model of the additional object.

9. The apparatus of claim 8, wherein the one or more processors are further configured to generate the 3D model of the additional object by generating a 3D morphable model (3DMM).

10. The apparatus of claim 8, wherein the additional object comprises a human head, and wherein the object comprises human hair on the human head.

11. The apparatus of claim 5, wherein:
the shape of the space comprises at least a portion of a sphere; and
to determine the position of the space, the one or more processors are configured to set a center associated with the sphere to be at a midpoint between two points on a 3D model of an additional object associated with the object.

12. The apparatus of claim 5, wherein:
the object includes human hair on a human head;
the shape of the space comprises at least a portion of a sphere; and
to determine the position of the space, the one or more processors are configured to set a center associated with the sphere to be at a midpoint between temple points on a 3D model of the human head.

13. The apparatus of claim 5, wherein:
the object includes human hair on a human head;
the shape of the space comprises at least a portion of a sphere; and
the one or more processors are configured to determine the scale associated with the space based on a distance from a back of the 3D model of the human head to a midpoint between temple points on a 3D model of the human head.

14. The apparatus of claim 13, wherein the one or more processors are configured to determine the scale associated with the space based on the distance and a padding distance associated with the human hair on the human head.

15. The apparatus of claim 14, wherein the one or more processors are further configured to determine the padding distance based on a style associated with the human hair.

16. The apparatus of claim 1, wherein the one or more processors are further configured to:
generate one or more other 3D models of the object at least in part by carving one or more other points associated with another space based on one or more other images depicting the object; and
generate an animation of the object based on the 3D model and the one or more other 3D models.

17. The apparatus of claim 1, wherein the one or more processors are further configured to determine that the one or more points are external to a representation of the object as shown by the one or more images.

18. The apparatus of claim 1, wherein carving the one or more points comprises designated the one or more points as being outside the 3D model of the object.

19. The apparatus of claim 1, wherein the space is represented by a signed distance function used to indicate, for each point of the space, a distance from each point to a closest point on a boundary associated with the object.

20. The apparatus of claim 19, wherein the distance is determined based on an L1 norm formula.

21. A method for model generation, comprising:
receiving one or more images depicting an object to be modeled;
determining a category associated with the object to be modeled;
selecting a shape of a space based on the category; and
generating a three-dimensional (3D) model of the object at least in part by carving one or more points associated with the space based on the one or more images depicting the object.

22. The method of claim 21, wherein selecting the shape of the space comprises selecting a space from multiple candidate spaces that is associated with the category.

23. The method of claim 21, wherein the category is determined based on user input.

24. The method of claim 21, further comprising analyzing, using a classification algorithm, the one or more images to determine the category.

25. The method of claim 21, further comprising determining a position and a scale associated with the space, wherein the 3D model of the object to be generated is enclosed within the space based on the determined position and scale.

26. The method of claim 25, wherein the position is determined to align a side of the space with a side of the 3D model to be generated.

27. The method of claim 26, wherein the side of the 3D model is associated with a side of the object that is not depicted in the one or more images.

28. The method of claim 25, further comprising generating a 3D model of an additional object that abuts the object, and wherein the position associated with the space is determined based on the 3D model of the additional object.

29. The method of claim 28, wherein the 3D model of the additional object is generated by generating a 3D morphable model (3DMM).

30. A non-transitory computer-readable medium having instructions stored thereon, which when executed by a processors, causes the processor to:
receive one or more images depicting an object to be modeled;
determine a category associated with the object to be modeled;
select a shape of a space based on the category; and
generate a three-dimensional (3D) model of the object at least in part by carving one or more points associated with the space based on the one or more images depicting the object.
